(19) United States
(12) Patent Application Publication
(10) Pub. No.: US 2026/0036817 A1
(43) Pub. Date: Feb. 5, 2026

(54) ILLUMINATION DEVICE AND DISPLAY DEVICE

(71) Applicant: Japan Display Inc., Tokyo (JP)

(72) Inventors: Jin HIROSAWA, Tokyo (JP); Shinichi KOMURA, Tokyo (JP); Koichi OKUDA, Tokyo (JP); Hiroaki KIJIMA, Tokyo (JP)

(73) Assignee: Japan Display Inc., Tokyo (JP)

(21) Appl. No.: 19/286,508

(22) Filed: Jul. 31, 2025

(30) Foreign Application Priority Data
Aug. 2, 2024 (JP) 2024-127820

(51) Int. Cl. G02B 27/01

(52) U.S. Cl. CPC G02B 27/0172; G02B 2027/0178

(57) ABSTRACT

According to an embodiment, an illumination device includes a first light guide having a cross-sectional shape of a first trapezoidal shape in which a lower side is shorter than an upper side, a second light guide having a cross-sectional shape of a second trapezoidal shape in which a lower side is longer than an upper side, and a plurality of light source elements, and light emitted from the light source elements enters the first light guide from the first surface, is totally reflected at the second surface and enters the second light guide, and the light entering the second light guide is totally reflected at the fourth surface.

### CROSS-REFERENCE TO RELATED APPLICATION

This application is based upon and claims the benefit of priority from Japanese Patent Application No. 2024-127820, filed Aug. 2, 2024, the entire contents of which are incorporated herein by reference.

### FIELD

Embodiments described herein relate generally to an illumination device and a display device.

### BACKGROUND

In a laser backlight that uses an element emitting laser light as a light source, a backlight which can uniformize the in-plane luminance distribution has been developed.

### BRIEF DESCRIPTION OF THE DRAWINGS

FIG. 1 is a perspective view showing an example of an appearance of a display device according to an embodiment.

FIG. 2 is a perspective view schematically showing a configuration of a display device provided in a display device according to an embodiment.

FIG. 3 is a cross-sectional view schematically showing a configuration example of a display device.

FIG. 4 is a plan view illustrating mixing of light.

FIG. 5 is a cross-sectional view schematically showing another configuration example of the display device.

FIG. 6 is a partially enlarged view showing an illumination device shown in FIG. 3.

FIG. 7 is another partial enlarged view of the illumination device shown in FIG. 3.

FIG. 8 is still another partial enlarged view of the illumination device shown in FIG. 3.

FIG. 9 is a diagram showing the relationship between an angle Aa and the ratio (d1/d0) of a thickness d1 to a thickness d0.

FIG. 10 is a diagram showing the relationship between an angle Aa and the ratio (ka/d0) of a thickness d1 to a distance ka.

FIG. 11 is a diagram showing an example of the case where the angle Aa is 61.75° (Aa=61.75°).

FIG. 12 is a diagram showing an example of the case where the angle Aa is 68° (Aa=68°).

### DETAILED DESCRIPTION

In general, according to one embodiment, an illumination device comprises
a first light guide having a cross-sectional shape of a first trapezoidal shape in which a lower side is shorter than an upper side; and
a second light guide provided on the first light guide and having a cross-sectional shape of a second trapezoidal shape in which a lower side is longer than an upper side, wherein
the first light guide has a first surface and a second surface disposed on an opposite side to the first surface, which corresponds to an oblique side of the first trapezoidal shape,
the second light guide has a third surface and a fourth surface disposed on an opposite side to the third surface, which corresponds to an oblique side of the second trapezoidal shape,
a plurality of light source elements is disposed to face the third surface of the second light guide, and
light emitted from the plurality of light source elements enters the first light guide from the first surface, is totally reflected by the second surface and enters the second light guide, and the light entering the second light guide is totally reflected by the fourth surface.

An object of this embodiment is to provide an illumination device with improved light extraction efficiency. With such an illumination device provided, another object is to provide a display device with improved brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction z is referred to as cross-sectional view.

### Embodiment

FIG. 1 is a perspective view showing an example of the appearance of a display device according to an embodiment. In the embodiment, the display device may be a head-mounted display (HMD) that is used while being worn on the user's head. Such a display device is used to provide, for example, virtual reality (VR) for a user who has the display device mounted on his/her head.

As shown in FIG. 1, the display device DSP comprises a display panel PNLh for the left eye and a display panel PNLm for the right eye. The display panel PNLh and the display panel PNLm may as well in some cases referred to as the first display panel and the second display panel, respectively. The display panel PNLh and the display panel PNLm are independent display panels.

The display panel PNLh and the display panel PNLm are disposed so that they are located in front of the left eye and right eye of the user USR, respectively, when the display device DSP is worn on the user's head. In the embodiment, it is assumed that the display panels PNLh and PNLm are liquid crystal display panels having a liquid crystal layer.

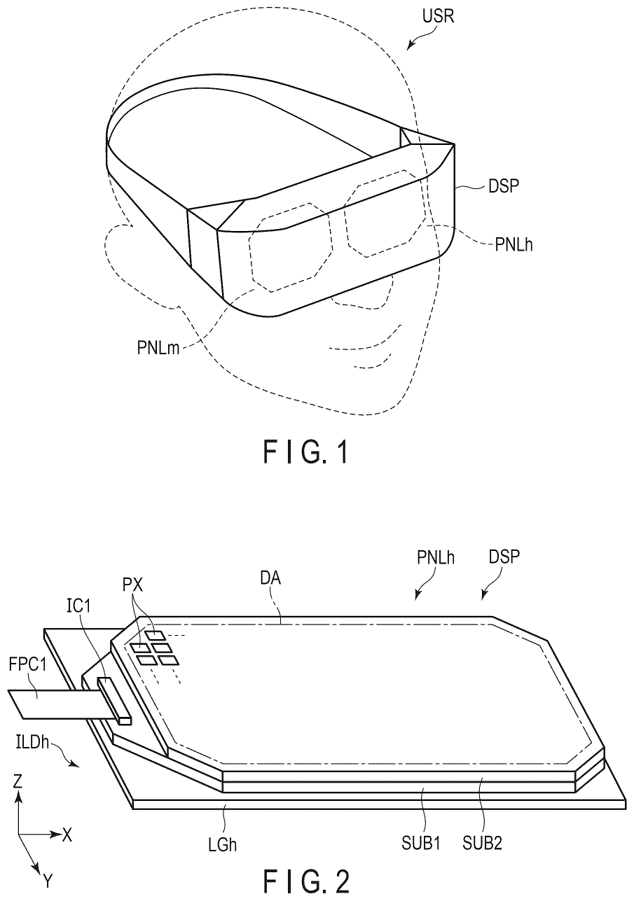

FIG. 2 is a perspective view schematically showing a configuration of the display device provided in the embodiment. Here, the configuration of the display panel PNLh will be mainly described.

The display panel PNLh shown in FIG. 2 comprises a first substrate SUB1 and a second substrate SUB2 facing the first substrate SUB1. Further, the display panel PNLh includes a display area DA that displays images. Furthermore, the display panel PNLh comprises a plurality of pixels PX arranged in a matrix pattern in the display area DA, for example.

On the other hand, the display panel PNLh comprises a drive IC chip IC1 that drives the display panel PNLh and a flexible circuit board FPC1 that transmits control signals to the display panel PNLh. The flexible circuit board FPC1 is connected to a control module (host computer) that controls the operation of the display device DSP.

In the example shown in FIG. 2, the first substrate SUB1 and the second substrate SUB2 each have long sides along the first direction X and short sides along the second direction Y. The first substrate SUB1 and the second substrate SUB2 each have an octagonal shape in plan view. This shape can also be described as a rectangular shape in which corners thereof are cut off. The shape of the display panel PNLh in plan as view is octagonal.

However, the shape of the display panel PNLh is not limited to this, and it suffices if the shape is any polygonal. It suffices if the display panel is of any shape that prevents it from coming into contact with the nose of the user USR, and it suffices if it has such a shape that corners that come close to the nose of the user USR are cut off.

In the example shown in FIG. 2, the shape of the display panel PNLh is discussed. The display panel PNLm has a shape that is line-symmetric with respect to the display panel PNLh in relation to the second direction Y as an axis. Except for the point that it has a shape that is line-symmetric with respect to the second direction Y, the configuration of the display panel PNLm is similar to that of the display panel PNLh.

Below the display panel PNLh, an illumination device ILDh is provided. In the example shown in FIG. 2, only the light guide LGh of the illumination device ILDh is shown. The light guide LGh has a rectangular shape extending along the first direction X and the second direction Y.

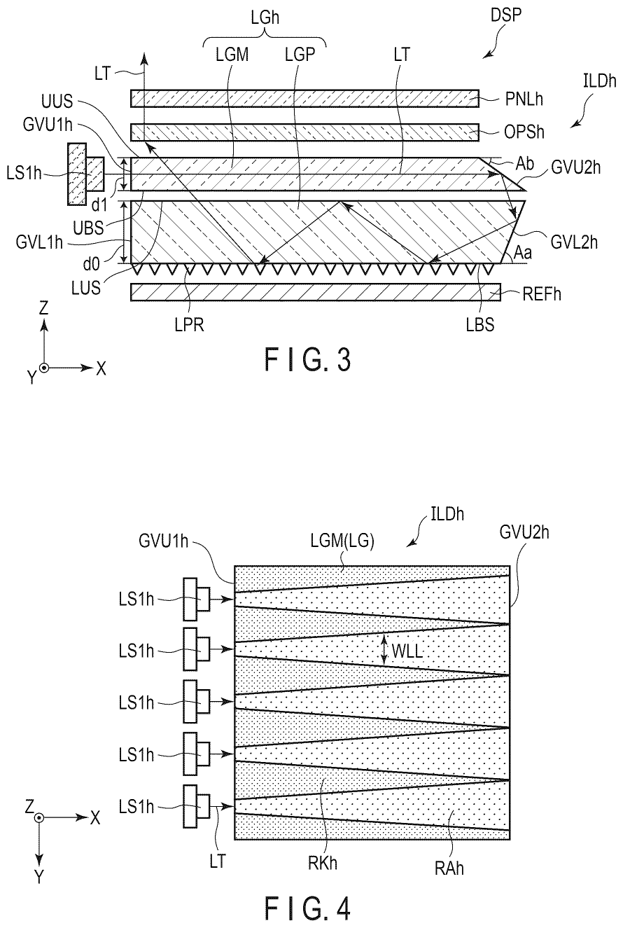

FIG. 3 is a cross-sectional view schematically showing a configuration example of the display device. The display device DSP shown in FIG. 3 comprises an illumination device ILDh and a display panel PNLh. The illumination device ILDh comprises a reflector REFh, an emission light guide LGP having an emission structure LPR for emitting light LT progressing within through the light guide from a surface LUS, which corresponds to the upper surface of the emission light guide LGP, a mixing light guide LGM for mixing laser light, an optical sheet OPSh, and a light source element LS1h. The reflector REFh, the emission light guide LGP, the mixing light guide LGM, and the optical sheet OPSh are stacked in this order.

The emission light guide LGP and mixing light guide LGM constitute the light guide LGh shown in FIG. 2. On the illumination device ILDh, a display panel PNLh is provided.

In FIG. 3, of surfaces of the mixing light guide LGM, the first surface on the left side of the page, which faces the light source element LS1h is designated as a surface GVU1h, and the second surface on the right side of the page, which reflects light is designated as a surface GVU2h. Of the surfaces of the emission light guide LGP, the third surface on the left side of the page, is designated as a surface GV1h, and the fourth surface on the right side of the page, which reflects light is designated as a surface GV2h.

Note that when viewed in cross-section, the surface GVU1h, which corresponds to the first surface, and the second surface GVU2h, which corresponds to the second surface, are referred to as the first edge and the second edge, respectively. Further, when viewed in cross-section, the surface GVL1h, which corresponds to the third surface, and the surface GVL2h, which corresponds to the fourth surface, are referred to as the third edge and the fourth edge, respectively. The surface GVU2h and surface GVL2h are inclined at an angle with respect to the Y-Z plane.

The emission light guide LGP has a trapezoidal cross-sectional shape in which the lower side is shorter than the upper side. The surface GVL1h, which corresponds to the left side of the trapezoidal shape, extends along the third direction Z. The surface GVL2h, which corresponds to the right side of the trapezoidal shape, extends and is inclined at an angle with respect to the third direction Z.

The lower surface of the emission light guide LGP is referred to as a surface LBS, and the upper surface is referred to as a surface LUS. The surface LBS faces the reflector REFh. The surface LUS faces the mixing light guide LGM. On the surface LBS, a plurality of emission structures LPR (which may as well be hereinafter referred to as protrusions, projections, grooves, or prisms) are provided. As will be described in detail later, light LT reflected by the emission structures LPR is emitted upward. The thickness of the emission light guide LGP (the distance along the third direction Z) is defined as a thickness do.

The mixing light guide LGM has a trapezoidal cross-sectional shape in which the lower side is longer than the upper side. The surface GVU1h, which corresponds to the left side of the trapezoidal shape, extends along the third direction Z. The surface GVU2h, which corresponds to the right side of the trapezoidal shape, extends at an angle with respect to the third direction Z. The thickness of the mixing light guide LGM is defined as a thickness d1. Thickness d1 is less than the thickness d0 (d1<d0).

The lower surface of the mixing light guide LGM is referred to as a surface UBS, and the upper surface is referred to as a surface UUS. The surface UBS faces the surface LUS of the emission light guide LGP. The surface UUS faces the optical sheet OPSh.

It suffices if the mixing light guide LGM and the emission light guide LGP are formed from transparent materials having the same refractive index. The refractive index of the transparent material should preferably close to that of air. Examples of such transparent materials include glass and organic resins having light transmittance. More specifically, examples of organic resins having light transmittance include acrylic resins.

The light source element LS1h is provided to face the surface GVU1h of the mixing light guide LGM. The light LT emitted from the light source element LS1h enters the mixing light guide LGM from the surface GVU1h of the mixing light guide LGM.

The light source element LS1h uses a laser light source (laser diode) such as a semiconductor laser that emits laser light. The laser light may be diffuse light having a spread centered on the irradiation direction, or may be polarized laser light.

The surface GVU2h, which corresponds to the second side, and the surface GVL2h, which corresponds to the fourth side, are inclined at an angle with respect to the Y-axis.

The angle of the surface GVL2h with respect to the second direction Y is denoted as an angle Aa. The angle of the surface GVU2h with respect to the second direction Y is denoted as an angle Ab.

On the main surfaces of the reflector REFh and the optical sheet OPSh, a plurality of protruding portions (which may as well be referred to as prisms) are provided. The optical sheet OPSh includes, for example, a prism sheet or a diffuser plate.

As described above, the light LT emitted from the light source element LS1h enters the surface GVU1h of the mixing light guide LGM. The entering light LT propagates from the surface GVU1h to the surface GVU2h. Of the light LT that reaches the surface GVU2h, light that satisfies the total internal reflection condition is reflected downward at the surface GVU2h and then enters the emission light guide LGP.

Of the light having entered the emission light guide LGP, light that satisfies the total internal reflection condition is reflected at the surface GVL2h and reaches the surface LBS. The light LT is repeatedly reflected between the surface LBS and the surface LUS and propagates in the direction opposite to the first direction X.

When the propagating light LT enters the emission structure LPR provided on the surface LBS, which corresponds to the lower surface of the emission light guide LGP, the light LT is reflected by the emission structure LPR and lifted upward. The light LT lifted upward is emitted from the emission light guide LGP, passes through the mixing light guide LGM, and enters the optical sheet OPSh. The light LT having entered the optical sheet OPSh is emitted upward along a direction parallel to the third direction Z by the protruding portions provided on the optical sheet OPSh. The light LT enters the display panel PNLh from the optical sheet OPSh.

FIG. 4 is a plan view illustrating the mixing of light. As to the illumination device ILDh shown in FIG. 4, only the light source element LS1h and the mixing light guide LGM are shown.

The light LT emitted from the light source element LS1h enters the mixing light guide LGM from the surface GVU1h. The light LT propagates through the interior of the mixing light guide LGM with a light beam width WLL (length along the second direction Y). When the light source element LS1h is a laser light source (laser diode), the laser light has high straight directionality, and therefore the light beam width WLL is short in the vicinity of the surface GVU1h. Therefore, beams of the light LT emitted from each of the multiple light source elements LS1h do not mix with each other (no mixing occurs). Therefore, bright regions RAh and dark regions RKh are generated in the mixing light guide LGM.

While the light LT is propagating from the surface GVU1h to the surface GVU2h, the light beam width WLL increases. In the vicinity of the surface GVU2h, beams of the light LT emitted from the multiple light source elements LS1h mixes with each other (mixing occurs), forming the light LT having uniform luminescence.

From the above, the width (length along the second direction Y) of the bright region RAh becomes narrower as the location is closer to the light source element LS1h. The width of the bright region RAh becomes wider as the location is farther away from the light source element LS1h.

The light LT having uniform luminescence is reflected downward as described above at the surface GVU2h and enter the light guide LGP from the surface LUS, which corresponds to the upper surface of the light guide LGP.

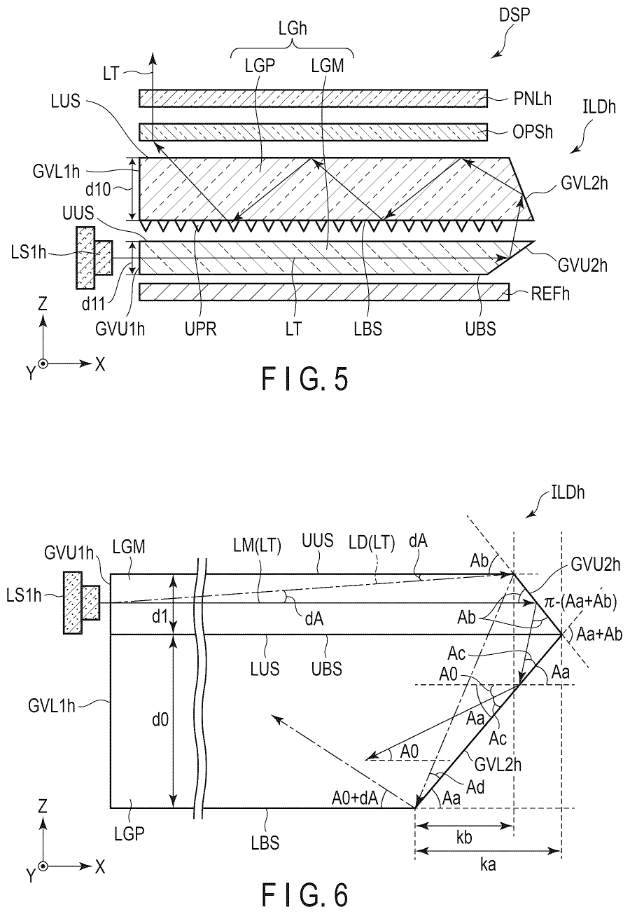

FIG. 5 is a cross-sectional view schematically showing another configuration example of the display device. The mixing light guide LGM shown in FIG. 5 is the mixing light guide LGM shown in FIG. 3 disposed upside down. The emission light guide LGP shown in FIG. 5 has a trapezoidal cross-section along the X-axis, and the length of the surface LBS along the X-axis direction, which is the bottom surface facing the mixing light guide LGM is longer than the length of the surface LUS along the first direction X, which is the upper surface. In FIG. 5, the reflector REFh, the mixing light guide LGM, the emission light guide LGP, and the optical sheet OPSh are stacked in this order.

In the illumination device ILDh shown in FIG. 5, points similar to those of the illumination device ILDh shown in FIG. 3 are omitted by reference to the illustration of FIG. 3. Now, the differences between the illumination device ILDh shown in FIG. 5 and the illumination device ILDh shown in FIG. 3 will be described.

On the surface LBS, which corresponds to the lower surface of the emission light guide LGP, a plurality of emission structures UPR are provided. Light reflected by the multiple emission structures UPR is emitted upward.

The thickness of the mixing light guide LGM is defined as a thickness d11. The thickness of the emission light guide LGP is defined as a thickness d10. The thickness d10 is greater than the thickness d11 (d10>d11).

The light source element LS1h is provided to face the surface GVU1h of the mixing light guide LGM. The light LT emitted from the light source element LS1h enters the mixing light guide LGM from the surface GVU1h of the mixing light guide LGM.

The light LT having entered the light guide LGM propagates from the surface GVU1h to the surface GVU2h. The light LT having reached the surface GVU2h is totally reflected at the surface GVU2h and reflected upward, then enters the light guide LGM. The surface GVU2h is inclined such that the light from the light source element satisfies the total internal reflection condition.

The light having entered the emission light guide LGP is totally reflected at the surface GV2h and reaches the surface LUS. The light LT is repeatedly reflected between the surface LUS and surface LBS and propagates in the direction opposite to the first direction X.

When the propagating light LT enters the emission structure UPR provided on the surface LBS, the light LT is reflected by the emission structure UPR and lifted upward. The upwardly lifted light LT is emitted from the emission light guide LGP and enters the optical sheet OPSh. The light LT having entered the optical sheet OPSh is emitted upward along a direction parallel to the third direction Z by the protruding portions provided on the optical sheet OPSh. The light LT enters the display panel PNLh from the optical sheet OPSh.

In the illumination device ILDh shown in FIG. 5, the light LT having uniform luminescence enters the optical sheet OPSh from the surface LUS, which corresponds to the upper surface of the emission light guide LGP, and therefore the loss of light can be reduced, and the light can be supplied to the display panel efficiently.

In connection with the illumination device ILDh and the display device DSP described above, the configuration for most efficiently extracting light LT emitted from the light source element LS1h will now be described.

As an example, with the configuration of the illumination device ILDh shown in FIG. 3, the surface GVU2h of the mixing light guide LGM and the surface GVL2h of the emission light guide LGP need to satisfy the total internal reflection conditions in reflection of the light LT. If the surfaces GVU2h of the mixing light guide LGM and GVU2h of the emission light guide LGP do not satisfy the total internal reflection conditions, there is such a risk that light LT may not be totally reflected, thus not transmitted from the mixing light guide LGM to the emission light guide LGP, or may be emitted outward from the light guide LGH, or the like. As a result, the luminescence of the light extracted upward from the illumination device ILDh may decrease, and the extraction efficiency may be undesirably reduced.

FIG. 6 is a partial enlarged view of the illumination device shown in FIG. 3. As described above, the angle of the surface GVL2h with respect to the first direction X is defined as the angle Aa. The angle of the surface GVL2h with respect to the first direction X is defined as the angle Ab.

In addition, the difference in the distance along the first direction X between the surface LUS and surface LBS is defined as a distance ka. The difference in the distance along the first direction X between the surface UUS and surface UBS is defined as a distance kb. Note that the distance ka is the width of the surface GVL2h, and the distance kb is the width of the surface GVU2h.

Of the light LT emitted from the light source element, the main ray is designated as LM, and the diffused light is designated as LD. The diffused light LD is inclined at an angle dA from the main ray LM. The main ray LM progresses along the first direction X from the surface GVU1h toward the surface GVU2h.

The angle between the main light ray LM reflected by the surface GVU2h and reaching the surface GVL2h and the surface GVL2h is defined as an angle Ac. Here, the condition for the main light ray LM to form an angle A0 after entering the emission light guide LGP within the mixing light guide LGM will be determined. In (Equation 1), π is 180° (π=180°).

$$Ac = π - Ab - ( Aa + Ab ) = π - Aa - 2 Ab \qquad ( Equation 1 )$$

When the angle between the main light ray LM reflected at the surface GVL2h and the first direction X is the angle A0, then, Equation 2 can be derived.

$$Ac = Aa - A 0 \qquad ( Equation 2 )$$

Since the right-hand side of Equation 1 and the right-hand side of Equation 2 are equal, Equation 3 can be derived.

$$π - Aa - 2 Ab = Aa - A 0 \qquad ( Equation 3 )$$

As Equation (3) is converted, Equation (4) is yielded.

$$Aa + Ab = ( A 0 + π ) / 2 \qquad ( Equation 4 )$$

Let us consider now the condition under which all light rays (light L) including not only the main light ray LM but also the diffused light LD enter the emission light guide LGP. More specifically, the condition under which the light ray at an angle (A0+dA) is reflected by both the surface GVU2h and the surface GVL2h in the emission light guide LGP is shown in (Equation 5) described below.

As shown in FIG. 6, it is assumed that the diffused light LD is reflected at the surface GVU2h and then reaches the surface LBS without being reflected at the surface GVL2h. In this case, the diffused light LD enters the boundary between the surface LBS and the surface GVL2h. The angle formed between the diffused light LD and the surface GVL2h is denoted as an angle Ad.

$$Ad = Aa - ( A 0 + dA ) \qquad ( Equation 5 )$$

With the thickness d0 of the light guide LGP, the length ka of the surface GVL2h in the X-axis direction, and the angle Aa, (Equation 6) can be derived. As (Equation 6) is converted, (Equation 7) can be yielded.

$$tan Aa = d 0 / ka \qquad ( Equation 6 )$$

$$ka = d 0 / tan Aa \qquad ( Equation 7 )$$

With the angle Ad of the diffusing light diffuser LD, the thickness d1 of the mixing light guide LGM, and the distance kb along the first direction X between the end portion of the surface UUS, which corresponds to the upper surface of the mixing light guide LGM and the end portion of the surface LBS, which corresponds to the lower surface of the emission light guide LGP, (Equation 8) can be derived. From (Equation 8) and (Equation 5), (Equation 9) can be derived.

$$tan ( Aa + Ad ) = ( d 1 + d 0 ) / kb \qquad ( Equation 8 )$$

$$kb = ( d 1 + d 0 ) / tan ( Aa + Ad ) = ( d 1 + d 0 ) / tan [ 2 Aa - ( A 0 + da ) ] \qquad ( Equation 9 )$$

From (Equation 7) and (Equation 9), (Equation 10) can be derived.

$$ka - kb = d 1 / tan Ab = d 1 / tan [ ( A 0 + π ) / 2 - Aa ] \qquad ( Equation 10 )$$

From the above, (Equation 11) can be derived. When (Equation 11) is rearranged, (Equation 12), (Equation 13), (Equation 14), and (Equation 15) are obtained.

$$\frac{d 0}{tan Aa} - \frac{d 0 + d 1}{tan ( 2 Aa - ( A 0 + dA ) )} = \frac{d 1}{tan ( \frac{A 0 + π}{2} - Aa )} \qquad ( Equation 11 )$$

$$( \frac{1}{tan Aa} - \frac{1}{tan ( 2 Aa - ( A 0 - dA ) )} ) d 0 = ( \frac{1}{tan ( \frac{A 0 + π}{2} - Aa )} + \frac{1}{tan ( 2 Aa - ( A 0 + dA ) )} ) d 1 \qquad ( Equation 12 )$$

$$( tan ( 2 Aa - ( A 0 + dA ) ) tan ( \frac{A 0 + π}{2} - Aa ) - tan Aa tan ( \frac{A 0 + π}{2} - Aa ) ) d 0 = ( tan ( 2 Aa - ( A 0 + dA ) ) tan Aa + tan Aa tan ( \frac{A 0 + π}{2} - Aa ) d 1 \qquad ( Equation 13 )$$

$$d 1 = \frac{( \begin{matrix}tan ( 2 Aa - ( A 0 + dA ) ) tan ( \frac{A 0 + π}{2} - Aa ) \\ tan Aa tan ( \frac{A 0 + π}{2} - Aa )\end{matrix} - )}{\begin{matrix}tan ( 2 Aa - ( A 0 + d A ) ) tan Aa + \\ tan Aa tan ( \frac{A 0 + π}{2} - Aa )\end{matrix}} d 0 \qquad ( Equation 14 )$$

$$d 1 = \frac{\{ tan ( 2 Aa - ( A 0 + dA ) ) - tan Aa \} tan ( \frac{A 0 + π}{2} - Aa )}{\{ tan ( 2 Aa - ( A 0 + dA ) ) + tan ( \frac{A 0 + π}{2} - Aa ) \} tan Aa} \qquad ( Equation 15 )$$

From the above, the relationship between the thickness d0 of the emission light guide LGP and the thickness d1 of the mixing light guide LGM is expressed as (Equation 15).

In practice, if the thickness d1 of the mixing light guide LGM is less than that given by (Equation 15), the light LT enters the emission light guide LGP. Therefore, it is preferable that the thickness d1 should satisfy (Equation 16).

$$d 1 \leq \frac{\{ tan ( 2 Aa - ( A 0 + dA ) ) - tan Aa \} tan ( \frac{A 0 + π}{2} - Aa )}{\{ tan ( 2 Aa - ( A 0 + dA ) ) + tan ( \frac{A 0 + π}{2} - Aa ) \} tan Aa} d 0 \qquad ( Equation 16 )$$

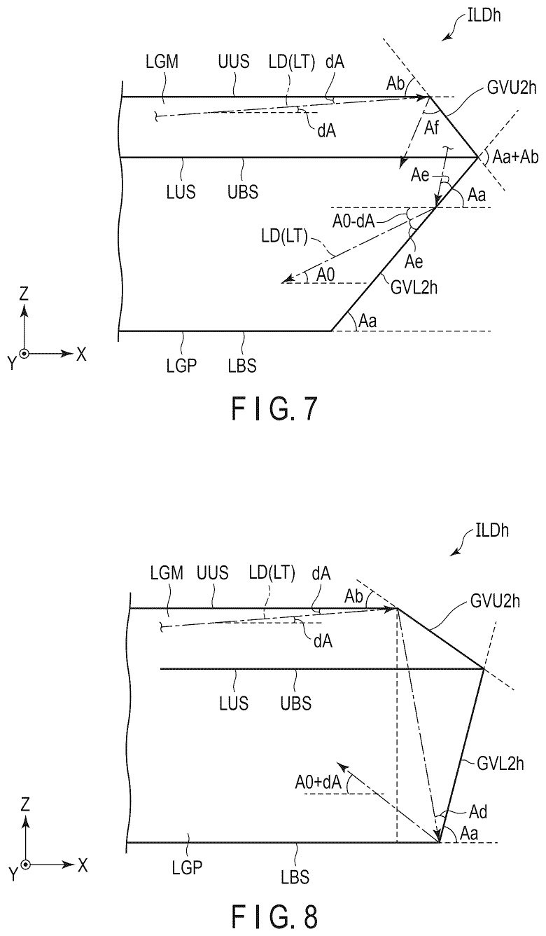

FIG. 7 is a partial enlarged view of the illumination device shown in FIG. 3. In FIG. 7, it is assumed that the mixing light guide LGM and the emission light guide LGP are formed from the same material. That is, the mixing light guide LGM and the emission light guide LGP have the same refractive index. Here, the total reflection angle at the time when light LT are totally reflected by the mixing light guide LGM and the emission light guide LGP is referred to as an angle F.

The condition for the light LT at an angle (A0−dA) to be totally reflected at the surface GVL2h is sought. Here, the angle between the diffused light LD reaching the surface GVL2h of the emission light guide LGP and the surface GVL2h is denoted as an angle Ae. This condition is expressed by (Equation 17).

$$Ae = Aa - ( A 0 - dA ) < F \qquad ( Equation 17 )$$

When (Equation (17)) is rearranged, Equation (18) can be yielded.

$$Aa < ( A 0 - dA ) + F \qquad ( Equation 18 )$$

It is assumed here that diffused light LD enters from the surface GVU1h of the mixing light guide LGM, and is totally reflected at the boundary between surface UUS and surface GVU2h, and then enters the emission light guide LGP. The angle between the diffused light LD and the surface GVU2h is denoted as an angle Af. The condition for the diffused light LD to be totally reflected at the surface GVU2h is expressed by (Equation 19).

$$Ab + dA < F \qquad ( Equation 19 )$$

From (Equation 19) and (Equation 4), (Equation 20) is obtained.

$$[ ( A 0 + π ) / 2 ] - Aa < F - dA \qquad ( Equation 20 )$$

From (Equation 20), (Equation 21) is obtained.

$$Aa > [ ( A 0 + π ) / 2 ] + dA - F \qquad ( Equation 21 )$$

FIG. 8 is a partial enlarged view of the illumination device shown in FIG. 3. In FIG. 8, the mixing light guide LGM and the emission light guide LGP are light guides that satisfy (Equation 22).

$$Aa + Ad > π / 2 \qquad ( Equation 22 )$$

Let us consider the condition where light LT, which satisfies the angle (A0+dA) of 33° (A0+dA=) 33°, is reflected on both the surface GVU2h and the surface GVL2h. When the angle (A0+dA) exceeds 33°, the total internal reflection condition is no longer satisfied. That is, the maximum angle at which the light LT can be totally reflected is that the angle (A0+dA) is 33° (A0+dA=) 33°.

When (Equation 22) holds, the angle Ad is expressed by (Equation 23).

$$Ad = Aa - ( A 0 + dA ) \qquad ( Equation 23 )$$

The angle Aa and angle Ab are expressed by Equations (24), (25), and (26), respectively.

$$Aa = d 0 / tan Aa \qquad ( Equation 24 )$$

$$\begin{matrix}Ab = \frac{d 0 + d 1}{tan ( π - ( Aa + Ad ) )} \\ = \frac{d 0 + d 1}{- tan ( Aa + Ad )} \\ = \frac{d 0 + d 1}{- tan ( 2 Aa - ( A 0 + dA ) )}\end{matrix} \qquad ( Equation 25 )$$

From (Equation 24) and (Equation 25), (Equation 26) is obtained.

$$Aa + Ab = \frac{d 1}{tan ( Ab )} = \frac{d 1}{tan ( \frac{A 0 + π}{2} - Aa )} \qquad ( Equation 26 )$$

From (Equation 24) to (Equation 26), (Equation 27) is obtained.

$$d 1 = \frac{\{ tan ( 2 Aa - ( A 0 + dA ) ) - tan Aa \} tan ( \frac{A 0 + π}{2} - Aa )}{\{ tan ( 2 Aa - ( A 0 + dA ) ) + tan ( \frac{A 0 + π}{2} - Aa ) \} tan Aa} d 0 \qquad ( Equation 27 )$$

(Equation 27) is the same as (Equation 15). That is, in FIGS. 6 and 8, the thickness d1 has the same value. In other words, (Aa+Ad)≤π/2 (see FIG. 6) and (Aa+Ad)>π/2 (see FIG. 8), the thickness d1 is expressed by the same equation.

The relationships among the thickness d0 of the emission light guide LGP, the thickness d1 of the mixing light guide LGM, the angle dA, which is the diffusion angle, the angle Aa, which is the angle of the surface GVL2h of the emission light guide LGP, and the distance ka, which is the width of the surface GVL2h, obtained from (Equation 16), (Equation 18), and (Equation 21), will now be described.

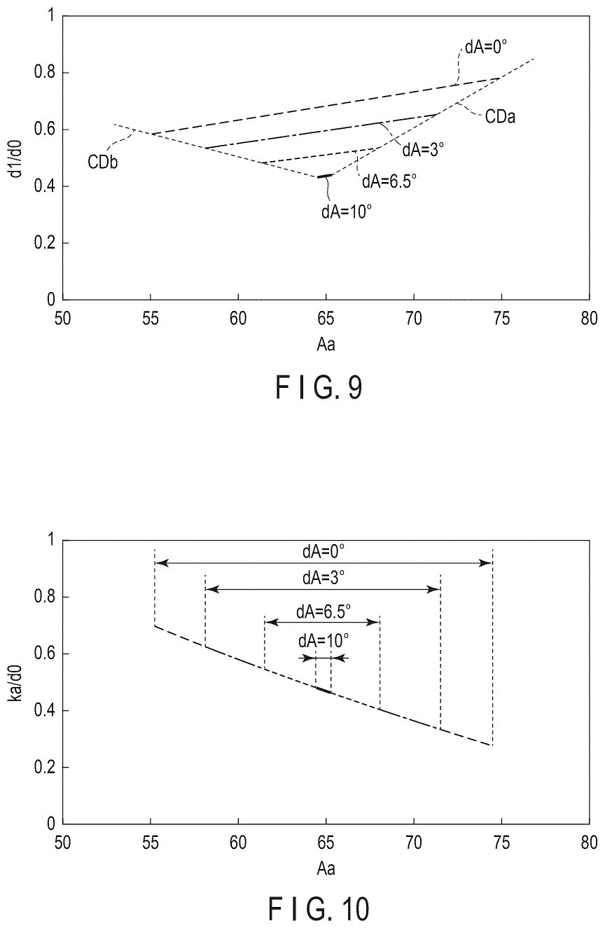

FIG. 9 is a diagram showing the relationship between the angle Aa and the ratio (d1/d0) of the thickness d1 to the thickness d0. In FIG. 9, a line CDa corresponds to (Equation 18). A line CDb corresponds to (Equation 21).

FIG. 10 is a diagram showing the relationship between the angle Aa and the ratio (ka/d0) of the thickness d1 to a distance ka.

As shown in FIGS. 9 and 10, the angle dA, which is the diffusion angle, should preferably be 6.5° or more and 10° or less. When the angle dA is 6.5° (dA=6.5°), the angle Aa can take values in a range of 61.75° or more and 68° (61.75°≤Aa≤68°). When the angle dA is 10° (dA=10°), the angle Aa can take values in a range of 64.5° or more and 65.3° or less (64.5°≤Aa≤65.3°).

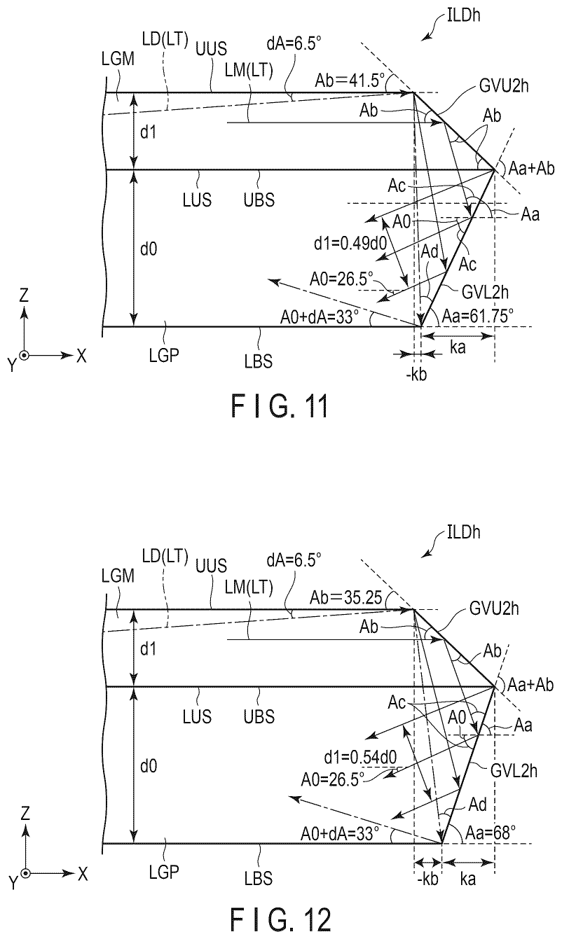

FIG. 11 is a diagram showing an example of the case where the angle Aa is 61.75° (Aa=61.75°). At this time, the angle A0 is 26.5° (A0=26.5°), and the light LT that satisfies that the sum of the angle A0 and angle dA is 33° (A0+dA=33°) satisfies the total internal reflection condition.

Since the angle Aa is 61.75°, the angle Ab is 41.5° (Ab=41.5°) from (Equation 4). The angle dA, which is the diffusion angle of the diffused light LD, is set to 6.5° (dA=6.5°). In other words, the illumination device ILDh comprises a light source element LS1h that emits light LT with a diffusion angle dA of 6.5°.

Using (Equation 15), d1=0.49d0 is obtained. Thus, it can be understood that the thickness d1 of the mixing light guide LGM is 0.49 times the thickness do of the emission light guide LGP.

FIG. 12 is diagram showing an example of the case where the angle Aa is 68° (Aa=68°). As in the case shown in FIG. 11, the angle A0 is 26.5° (A0=26.5°), and the light LT that satisfies that the sum of the angle A0 and angle dA is 33° (A0+dA=33°) satisfies the total internal reflection condition.

Since the angle Aa is 61.8°, the angle Ab is 35.25° (Ab=35.25°) from (Equation 4). The angle dA, which is the diffusion angle of the diffused light LD is set to 6.5° (dA=6.5°), as in the case shown in FIG. 11.

Using (Equation 15), d1=0.54d0 is obtained. Thus, it can be understood that the thickness d1 of the mixing light guide LGM is 0.54 times the thickness do of the emission light guide LGP.

As described above, the appropriate thicknesses d1 and do can be obtained from the angle Aa, angle dA, and angle A0. Further, once the thickness d1 is obtained, the appropriate distance ka and distance kb can be obtained.

In this disclosure, the emission light guide LGP and the mixing light guide LGM may as well be referred to as the first light guide and the second light guide, respectively. The surface GV1h and surface GV2h of the emission light guide LGP may as well be referred to as the first surface and the second surface, respectively. The surface GVU1h and surface GVU2h of the mixing light guide LGM may as well be referred to as the third surface and the fourth surface, respectively.

In this disclosure, the surface LBS and the surface LUS of the emission light guide LGP may as well be referred to as the first main surface and the second main surface, respectively. The surface UBS and surface UUS of the mixing light guide LGM may as well be referred to as the third main surface and the fourth main surface, respectively. The thickness d0 of the emission light guide LGP and the thickness d1 of the mixing light guide LGM may as well be referred to as the first thickness and the second thickness, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination device comprising:
a first light guide having a cross-sectional shape of a first trapezoidal shape in which a lower side is shorter than an upper side; and
a second light guide provided on the first light guide and having a cross-sectional shape of a second trapezoidal shape in which a lower side is longer than an upper side, wherein
the first light guide has a first surface and a second surface disposed on an opposite side to the first surface, which corresponds to an oblique side of the first trapezoidal shape,
the second light guide has a third surface and a fourth surface disposed on an opposite side to the third surface, which corresponds to an oblique side of the second trapezoidal shape,
a plurality of light source elements is disposed to face the third surface of the second light guide, and
light emitted from the plurality of light source elements enters the first light guide from the first surface, is totally reflected by the second surface and enters the second light guide, and the light entering the second light guide is totally reflected by the fourth surface.

2. The illumination device according to claim 1, wherein
a second thickness of the second light guide is less than a first thickness of the first light guide.

3. The illumination device according to claim 1, wherein
the first light guide comprises a first main surface on which corresponds to the lower side of the first trapezoidal shape
the first main surface has a plurality of protrusions.

4. The illumination device according to claim 1, wherein
the plurality of light source elements are laser light source elements.

5. A display device comprising:
the illumination device according to claim 1; and
a display panel provided on the illumination device.
